(19) United States
(12) Patent Application Publication
(10) Pub. No.: US 2023/0119405 A1
(43) Pub. Date: Apr. 20, 2023

(54) Computer-Based Systems and Methods for Sentiment Analysis

(71) Applicant: Executive Development Associates, Inc., Oklahoma City, OK (US)

(72) Inventors: Bonnie K. Timms, Kearney, MO (US); Demetri Poulikidis, Vienna (AT); Gian Colombo, Winter Park, FL (US); Daniel Corlette, Gulf Breeze, FL (US); Maria Navarro, Davenport, IA (US)

(21) Appl. No.: 18/047,805

(22) Filed: Oct. 19, 2022

Related U.S. Application Data
(60) Provisional application No. 63/257,153, filed on Oct. 19, 2021.

(51) Int. Cl. G06Q 10/06

(52) U.S. Cl. CPC G06Q 10/06393; G06N 20/00

(57) ABSTRACT

Computer-based systems and methods for sentiment analysis are disclosed, including a computerized system, comprising one or more non-transitory computer readable medium storing computer executable instructions that, when executed, cause one or more processors to: receive digital employee communications; and determine employee sentiment from the digital employee communications by analyzing the digital employee communications utilizing a language model generated by machine learning algorithms. In some implementations, the executable instructions, when executed, may cause the one or more processors to determine whether the employee communications include indications of employee sentiment about one or more organizational categories and/or may determine trends in or predictions of employee sentiment.

### CROSS-REFERENCE TO RELATED APPLICATIONS

This application claims the benefit of and priority to the U.S. provisional patent application identified by Ser. No. 63/257,153, filed on Oct. 19, 2021, titled “Computer-Based Systems and Methods for Sentiment Analysis”, the entire contents of which are hereby expressly incorporated herein by reference.

### BACKGROUND

The present invention deals with computer-based systems and methods for sentiment analysis of employee-generated data. Sentiment analysis is the use of automated computer processing to identify and analyze information that indicates sentiment, tone, opinion, or emotion of participants.

Most commercial organizations rely on a fragmented number of individuals to carry out business operations. For organizations that employ a large number of people, it is often difficult to appraise the collective and individual sentiment of its employees, or to identify leaders and key drivers of success within a team of employees. Employee sentiment towards management, coworkers, and other entities is a critical element that bears on company morale, corporate culture, productivity, and in turn, the overall success of an organization. The ability of an organization to identify sentiment and, perhaps more importantly, real-time shifts in sentiment among its employees, allows organizations to react and respond appropriately to situations that may arise during the course of business, or to act proactively to maintain successful business operations.

Moreover, the use of communication tools, such as e-mail, chat, and other messaging applications, is a pervasive staple in commercial industry and results in the generation of an extraordinary volume of intra-company communications. These communication tools allow for rapid, widespread dissemination of information. Although the subject matter of these communications is generally regarding business operations, the content of these communications provides a wealth of information regarding the present sentiment, tone, opinion, and emotion of the communicating employees.

The detection and analysis of these communications aid organizations in making strategic decisions regarding business operations. For instance, the company may wish to know whether employees like or dislike certain company policies or management styles. If, for example, a large number of employees indicate a dislike for a newly implemented company policy, management may determine that the policy needs to be amended or discontinued. On the other hand, the company may deem the policy to be beneficial to business operations and could engage in employee education to better communicate the value propositions of the policy so as to alleviate negative employee sentiment. An organization may also utilize sentiment analysis to gauge the impact of an event on employee morale, such as, for example, following an acquisition or a leadership meeting.

In the past, culture and leadership have been viewed as abstract concepts, making it difficult for organizations, especially organizations employing a large number of individuals, to discern employee sentiment in any meaningful way. This is especially true where, for example, the corporate culture of an organization tends to, either directly or indirectly, dissuade employees from openly communicating with management about perceived shortcomings for fear of reprisal. Even then, organizations relied on human analysis of employee sentiment based on a single culture or engagement survey, conversations, observations, etc., which often results in inadequate measures of employee sentiment.

Previous systems took a snapshot of employee feedback through single point-in-time surveys. However, previous systems did not measure real-time sentiment, identify shifts in sentiment, or generate a predictive model of where employee sentiment is headed in the future based on trends within the organization or the industry as a whole. Further, previous systems did not fuse, integrate, or otherwise merge, historical and forecasted/predicted changes in employee sentiment from one data source with other related data sources to generate a predictive model of where employee sentiment is headed in the future in the context of other related data sources.

What is needed are systems and methods that are configured to identify relational interactions between survey data and other sources datasets to identify opportunities, insights, and action plans for remediation. Further, what is needed are systems and methods that are configured to provide correlational impact metrics across time on the influence of company processes and/or operations on sentiment and culture.

An organization can glean meaningful insight into employee sentiment based on the classifications rendered by sentiment analysis. Therefore, automated systems and methods for sentiment analysis within organizations are needed.

### SUMMARY

Computerized methods and systems are disclosed to determine sentiment of employees in an organization through analysis of passive and/or interactive inputs from employees. Computerized systems and methods are disclosed that may be configured to identify relational interactions between survey data and other sources datasets to identify opportunities, insights, and action plans for remediation. Computerized systems and methods are disclosed that may be configured to provide correlational impact metrics across time on the influence of company processes and/or operations on sentiment and culture.

The problems of determining employee sentiment are solved, including through some implementations utilizing a computerized system, comprising one or more non-transitory computer readable medium storing computer executable instructions that, when executed cause one or more processors to: receive digital employee communications; and determine employee sentiment from the digital employee communications by analyzing the digital employee communications utilizing a language model generated by machine learning algorithms.

In some implementations, the digital employee communications may contain text. In some implementations, the digital employee communications are at least partially converted to text from one or more other formats.

In some implementations, the machine learning algorithms may include one or more of linear regression, logistic regression, polynomial regression analysis, neural networks, and Bayesian modeling.

In some implementations, determining employee sentiment may further comprise determining employee sentiment for one or more organizational categories. In some implementations, the one or more organizational categories include, for example, one or more of vision and strategy, values, leadership, supervision, communication, innovation and change management, customer centricity, social impact, diversity, inclusion, engagement, teamwork, and learning and development. In some implementations, determining employee sentiment from the digital employee communications by analyzing the digital employee communications utilizing the language model generated by machine learning algorithms may further comprises determining whether the employee communications include indications of employee sentiment about one or more of the organizational categories.

In some implementations, the one or more non-transitory computer readable medium may store computer executable instructions that, when executed, cause the one or more processors to assign a fit score to a corresponding determination of whether the employee communications include indications of employee sentiment about one or more of the organizational categories, wherein the fit score is indicative of a relational probability of the employee communication fitting into the organizational category.

In some implementations, the one or more non-transitory computer readable medium may store computer executable instructions that, when executed, cause the one or more processors to determine future trends of employee sentiment by tracking the determined employee sentiment over time.

In some implementations, the one or more non-transitory computer readable medium may store computer executable instructions that, when executed, cause the one or more processors to analyze the determined employee sentiment using a second model generated by machine learning algorithms to produce predictions about organizational performance.

In some implementations, computerized systems and methods may be configured for transmitting a query to one or more employee-computer devices, receiving an employee response to the query, and comparing the employee response with a score rubric that corresponds to the query. Responses may be assigned a corresponding evaluated score based on the score rubric. In some implementations, the evaluated score may be analyzed to determine employee sentiment directed towards an entity associated with the query. The evaluated score may be analyzed by comparing the evaluated score with a threshold value based on the determined entity to determine whether the employee sentiment is one of: a positive sentiment, a negative sentiment, and a neutral sentiment, for example. Once employee sentiment has been determined, one or more managerial/executive employees may be sent one or more notification indicative of the employee sentiment and/or given access to one or more dashboard having data indicative of the employee sentiment for two or more employees as one or more group.

In some implementations, the computerized methods and systems determine overall employee sentiment that may be detailed in resulting reports at a team level, but not at an individual level, in order to protect rights and privacy of individual employees while informing leadership, such as via reporting “dashboards.”

The computerized methods and systems may determine an organizational sentiment baseline. As a non-exclusive example, the computerized methods and systems may store, for example, the query, evaluated score, and employee sentiment, and after a period of time, may determine the sentiment baseline of the organization. In some implementations, the period of time may be twelve months. The computerized methods and systems may use the organizational sentiment baseline to determine shifts in employee sentiment from the organizational sentiment baseline.

The computerized methods and systems may also include customizable templates of commonly used surveys for departments in the organization, including proprietary Human Resources and Leadership development surveys. Examples of the customizable templates may include, for example, one or more of: a culture survey; Leadership Effectiveness Survey, a 360-degree survey; a team survey; and/or a Return-On-Investment Survey. The computerized methods and systems may collect data collected from several surveys, such as one or more of the above-mentioned surveys, and store that data in a database for further analysis. The computerized methods and systems may also utilize artificial intelligence such as machine learning, to analyze and/or recognize patterns in employee communications, e.g., e-mail, chat, listening bot, etc., that may be indicative of a particular employee sentiment.

The data collected from the surveys, and the data collected from employee communications may be analyzed together and/or separately. The data may be sorted into core areas that impact organizational culture, such as, for example, one or more of categories, nonexclusive examples of which include: (1) Vision and Strategy, (2) Values, (3) Executive/Sr. Leadership, (4) Immediate Supervision, (5) Communication, (6) Innovation/Change Management, (7) Customer Centricity, (8) Social Impact, (9) Diversity and Inclusion, (10) Engagement, (11) Teamwork, and (12) Learning and Development. Results of the analysis of this data may be presented in real-time in a report, such as a dashboard, accessible by users, and the computerized method and systems may provide expert guidance based on the results of the analysis. The dashboard may present different information based on a user's position in an organizational hierarchy. For example, a dashboard may be provided to organizational leadership that permits users to drill down to the organizational team level. On the other hand, another dashboard may be presented if the user is a member of the Board of Directors, an investor, or a potential employee; this dashboard contains more high-level information, which meets the informational demands of the particular user.

The computerized method and systems may also include administrative credentials which permits a user to create and customize the several surveys. Over time, the computerized method and systems may determine a normal distribution (“norm”) of employee sentiment for each particular organization. In some implementations, the computerized method and systems may create a bell-curve reflecting that distribution. The computerized method and systems may determine deviations from the norm for that particular organization. For example, the computerized method and systems may alert a user, such as the CEO or C-suite designated leader, when employee sentiment varies greater than +/−1 standard deviation from the norm on one or more of the core areas listed above. The computerized method and systems may generate predictive modeling data regarding the possible impact intervention and/or proactive attention may have on employee sentiment going forward. Further, the computerized method and systems may generate predictions of other business metrics based on the results of the modeling of employee sentiment.

### BRIEF DESCRIPTION OF THE SEVERAL VIEWS OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagrammatic view of hardware forming an exemplary embodiment of a system for computerized sentiment analysis in accordance with the present disclosure.

FIG. 2 is a diagrammatic vide of an exemplary employee-computer device for use in the system for computerized sentiment analysis illustrated in FIG. 1.

FIG. 3 is a diagrammatic view of an exemplary embodiment of a host system for use in the system for computerized sentiment analysis illustrated in FIG. 1.

FIG. 4 is an exemplary flow chart of computer executable code in accordance with the present disclosure.

FIG. 5 is an illustration of an exemplary query screen in accordance with some embodiments of the present disclosure.

FIG. 6 is an illustration of an exemplary query creation screen in accordance with some embodiments of the present disclosure.

FIG. 7 is an illustration of an exemplary score rubric screen in accordance with some embodiments of the present disclosure.

FIG. 8 is an illustration of an exemplary sentiment report in accordance with some embodiments of the present disclosure.

FIG. 9 is an illustration of an exemplary organizational performance report in accordance with some embodiments of the present disclosure.

FIG. 10 is an illustration of another exemplary organizational performance report in accordance with some embodiments of the present disclosure.

FIG. 11 is an exemplary flow chart of computer executable code in accordance with the present disclosure.

FIG. 12 is a diagrammatic view of hardware forming an exemplary embodiment of a system for computerized sentiment analysis in accordance with the present disclosure.

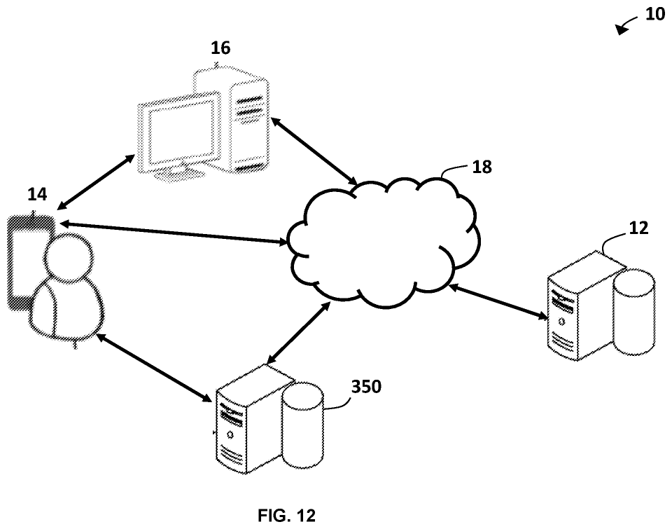

### DETAILED DESCRIPTION

Before explaining at least one embodiment of the inventive concept disclosed herein in detail, it is to be understood that the inventive concept is not limited in its application to the details of construction and the arrangement of the components or steps or methodologies set forth in the following description or illustrated in the drawings. The inventive concept disclosed herein is capable of other embodiments or of being practiced or carried out in various ways. Also, it is to be understood that the phraseology and terminology employed herein is for the purpose of description and should not be regarded as limiting in any way. No element, act, or instruction used in the present application should be construed as critical or essential to the invention unless explicitly described as such.

In the following detailed description of embodiments of the inventive concept, numerous specific details are set forth in order to provide a more thorough understanding of the inventive concept. It will be apparent to one of ordinary skill in the art, however, that the inventive concept within the disclosure may be practiced without these specific details. In other instances, well-known features have not been described in detail to avoid unnecessarily complicating the instant disclosure.

As used herein, the terms “comprises”, “comprising”, “includes”, “including”, “has”, “having”, or any other variation thereof, are intended to be non-exclusive inclusions. For example, a process, method, article, or apparatus that comprises a set of elements is not limited to only those elements but may include other elements not expressly listed or even inherent to such process, method, article, or apparatus.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, the use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise.

Further, use of the term “plurality” is meant to convey “more than one” unless expressly stated to the contrary.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

The phrase “based on” is intended to mean “based, at least in part, on” unless explicitly stated otherwise.

Circuitry, as used herein, may be analog and/or digital components, or one or more suitably programmed processors (e.g., microprocessors) and associated hardware and software, or hardwired logic. Also, “components” may perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that the algorithms described herein may be stored on one or more non-transitory memory. Exemplary non-transitory memory may include random access memory, read only memory, flash memory, and/or the like. Such non-transitory memory may be electrically based, optically based, and/or the like.

The phrase “manager” or “manager employee,” as used herein, may include the Chief Executive Officer of an organization, and other C-suite employees.

The phrase “employee sentiment,” as used herein, refers to the collective sentiment of employees of an organization.

Finally, as used herein any reference to “one embodiment” or “an embodiment” or “implementation” means that a particular element, feature, structure, or characteristic described in connection with the embodiment is included in at least one embodiment. The appearance of the phrases “in one embodiment”, “in one implementation”, or “in some implementations” in various places in the specification are not necessarily all referring to the same embodiment.

As discussed above, determining sentiment, shifts in sentiment, and predicting direction of sentiment, of employees in an organization is problematic and may also require a large amount of resources, including time and manpower. The present disclosure addresses these deficiencies with computerized systems and methods for determining employee sentiment through analysis of passive and/or active employee input. Further, the systems and methods may provide enterprise-wide surveys, survey templates, and reports.

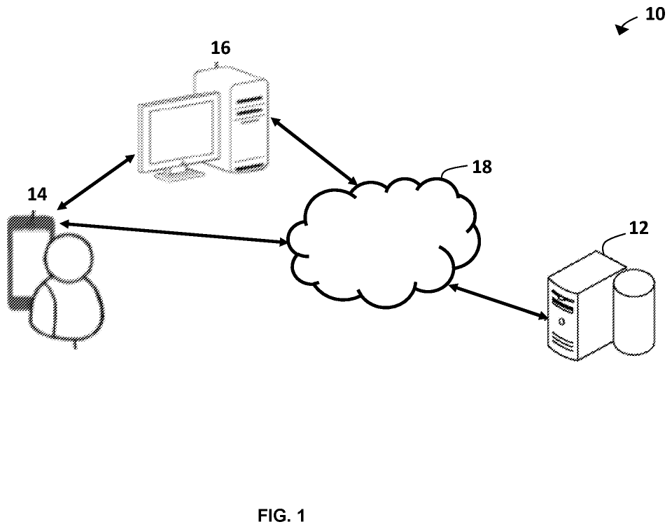

Referring now to FIG. 1, shown therein is a diagrammatic view of hardware forming an exemplary embodiment of a computerized sentiment analysis system 10 constructed in accordance with the present disclosure.

The sentiment analysis system 10 may include one or more of: host systems 12, employee-computer devices 14, manager-computer devices 16, and network 18. The sentiment analysis system 10 may be a system or systems that are able to embody and/or execute the logic of the processes described herein. Logic embodied in the form of software instructions and/or firmware may be executed on any appropriate hardware. For example, logic embodied in the form of software instructions and/or firmware may be executed on a dedicated system or systems, on a personal computer system, on a distributed processing computer system, and/or the like. In some embodiments, logic may be implemented in a stand-alone environment operating on a single computer system and/or logic may be implemented in a networked environment such as a distributed system using multiple computers and/or processors, as depicted in FIG. 1, for example.

In some embodiments, the sentiment analysis system 10 may be distributed, and include at least one host system 12 communicating with one or more employee-computer device 14 via the network 18. As used herein, the terms “network-based,” “cloud-based,” and any variations thereof, are intended to include the provision of configurable computational resources on demand via interfacing with a computer and/or computer network, with software and/or data at least partially located on a computer and/or computer network.

In some embodiments, the network 18 may be the Internet and/or other network. For example, if the network 18 is the Internet, a primary user interface of the system 10 may be delivered through a series of web pages or private internal web pages of a company or corporation, which may be written in hypertext markup language. It should be noted that the primary user interface of the system 10 may be another type of interface including, but not limited to, a Windows-based application, a tablet-based application, a mobile web interface, and/or the like.

The network 18 may be almost any type of network. For example, in some embodiments, the network 18 may be a version of an Internet network (e.g., exist in a TCP/IP-based network). It is conceivable that in the near future, embodiments within the present disclosure may use more advanced networking technologies.

As described herein, the employee-computer device 14 and the manager-computer device 16 may be implemented as similar devices. Therefore, in the interest of brevity, the elements of the employee-computer device 14 and the manager-computer device 16 will be described herein using the same numerical designations.

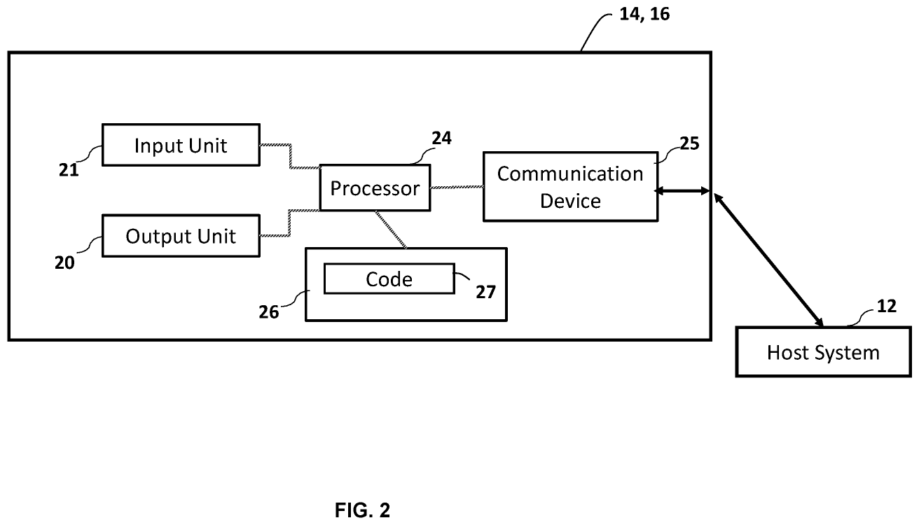

As shown in FIG. 2, the employee-computer device 14 and the manager-computer device 16 of the system 10 may include, but are not limited to, implementation as a personal computer, a cellular telephone, a smart phone, a tablet, a laptop computer, a desktop computer, a network-capable handheld device, a server, a wearable network-capable device, and/or the like.

In some embodiments, the employee-computer device 14 and the manager-computer device 16 may include one or more of: output unit 20, input unit 21, processor(s) 24, communication devices 25 capable of interfacing with the network 18, non-transitory memory 26 storing processor-executable code 27 (which may include software application(s). The processor-executable code 27 may include, for example, a web browser capable of accessing a website and/or an application capable of communicating information and/or data over a wireless or wired network (e.g., network 18), and/or the like.

Embodiments of the system 10 may also be modified to use any future developed devices capable of communicating with the host system 12 via the network 18 as the employee-computer device 14 and/or the manager-computer device 16.

The input unit 21 may be configured to receive information input from the employee-computer device 14 and/or other processor(s) 24, and transmit such information to other components of the employee-computer device 14, the manager-computer device 16, and/or the network 18. The input unit 21 may include, but is not limited to, implementation as a keyboard, touchscreen, mouse, trackball, microphone, slide-out keyboard, flip-out keyboard, cell phone, PDA, remote control, fax machine, wearable communication device, network interface, combinations thereof, and/or the like, for example. In some embodiments, the non-transitory memory 26 is loaded with computer executable instructions.

The output unit 20 may be capable of outputting information in a form perceivable by the user and/or processor(s) 24. For example, implementations of the output unit 20 may include, but are not limited to, a computer monitor, a screen, a touchscreen, a speaker, a website, a television set, a smart phone, a PDA, a cell phone, a printer, a laptop computer, combinations thereof, and the like, for example. It is to be understood that in some exemplary embodiments, the input unit 21 and the output unit 20 may be implemented as a single device, such as, for example, a touchscreen of a computer, a tablet, or a smartphone. It is to be further understood that as used herein the term user is not limited to a human being, and may comprise, a computer, a server, a website, a processor, a network interface, a human, a user terminal, a virtual computer, combinations thereof, and/or the like, for example.

The host system 12 may be configured to interface and/or communicate with the employee-computer device 14 and the manager-computer device 16 via the network 18. For example, the host system 12 may be configured to interface by exchanging signals (e.g., analog, digital, optical, and/or the like) via one or more ports (e.g., physical ports or virtual ports) using a network protocol, for example. Additionally, the host system 12 may be configured to interface and/or communicate with other host systems 12 directly and/or via the network 18, such as by exchanging signals (e.g., analog, digital, optical, and/or the like) via one or more ports.

As shown in FIG. 1, the network 18 may permit bi-directional communication of information and/or data between the host system 12, the employee-computer device 14 and/or the manager-computer device 16. The network 18 may interface with the host system 12, the employee-computer device 14 and/or the manager-computer device 16 in a variety of ways. For example, in some embodiments, the network 18 may interface by optical and/or electronic interfaces, and/or may use a plurality of network topographies and/or protocols including, but not limited to, Ethernet, TCP/IP, circuit switched path, combinations thereof, and/or the like. For example, in some embodiments, the network 18 may be implemented as the World Wide Web (or Internet), a local area network (LAN), a wide area network (WAN), a metropolitan network, a 4G network, a satellite network, a radio network, an optical network, a cable network, a public switch telephone network, an Ethernet network, combinations thereof, and the like, for example. Additionally, the network 18 may use a variety of network protocols to permit bi-directional interface and/or communication of data and/or information between the host system 12, the employee-computer device 14 and/or the manager-computer device 16.

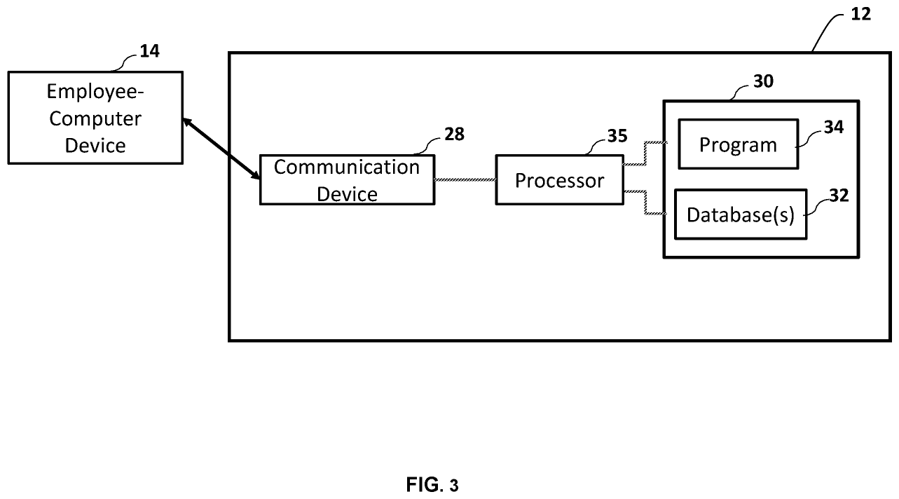

Referring now to FIG. 3, shown therein is a diagrammatic view of an exemplary embodiment of the host system 12. In the illustrated exemplary embodiment, the host system 12 is provided with one or more of: communication device 28, non-transitory computer readable medium 30, databases 32, program logic 34 in the form of computer-executable instructions, and processors 35.

Data transmission from the employee-computer device 14, or the manager-computer device 16, via the communication device 28 are processed by the program logic 34, organized by the database 32 functionality and stored by the non-transitory computer readable medium 30.

The program logic 34 and the database 32 may be stored on the non-transitory computer readable medium 30, accessible by the processor 35 of the host system 12. It should be noted that as used herein, program logic 34 is another term for instructions which can be executed by the processor 35 of the host system 12 and/or by the processor 35 of the employee-computer device 14 and/or the manager-computer device 16.

The database 32 may be a relational database or a non-relational database. Nonexclusive examples of such databases include: DB2® produced by IBM of 1 New Orchard Road Armonk, N.Y. 10504-1722; Microsoft® Access or Microsoft® SQL Server or Microsoft® MySQL produced by Microsoft Corporation of One Microsoft Way, Redmond, Wash. 98052; Oracle® produced by Oracle of 2300 Oracle Way Austin, Tex. 78741; PostgreSQL (an open source database), MongoDB produced by MongoDB of 1633 Broadway, 38^{th} Floor, New York, N.Y. 10019; Apache Cassandra (an open source database), and the like. It should be understood that these examples have been provided for the purposes of illustration only and should not be construed as limiting the presently disclosed inventive concepts. The database 32 can be centralized or distributed across multiple systems.

In some embodiments, the host system 12 may comprise one or more processors 35 working together, or independently, to execute the program logic 34 stored on the non-transitory computer readable medium 30. Additionally, the host system 12 may include at least one communication device 28 configured to interface with the employee-computer device 14, or the manager-computer device 16, and configured to interface with processor-executable code 27 via the network 18. One or more elements of the host system 12 may be partially or completely network-based or cloud-based, and may or may not be located in a single physical location. The host system 12 may include a single processor 35 or multiple processors 35 working together or independently to perform a task. The host system 12 may or may not be located in single physical location. Additionally, multiple host systems 12 may or may not necessarily be located in a single physical location.

It is to be understood, that in certain embodiments using more than one processor 35, the processors 35 may be located remotely from one another, located in the same location, or comprising a unitary multi-core processor. The processor 35 may be capable of reading and/or executing processor executable code and/or capable of creating, manipulating, retrieving, altering, and/or storing data structures into the non-transitory computer readable medium 30.

Exemplary embodiments of the processor 35 of the host system 12 may include, but are not limited to, a digital signal processor (DSP), a central processing unit (CPU), a field programmable gate array (FPGA), a microprocessor, a multi-core processor, combinations, thereof, and/or the like, for example. The processor 35 may be capable of communicating with the non-transitory computer readable medium 30 via a path (e.g., data bus). The processor 35 may be capable of communicating with the communication device 28 via a path, such as a data bus.

The processor 35 may be further configured to interface and/or communicate with the employee-computer device 14, and/or the manager-computer device 16, via the network 18. For example, the processor 35 may be configured to communicate via the network 18 by exchanging signals (e.g., analog, digital, optical, and/or the like) via one or more ports (e.g., physical or virtual ports) using a network protocol to provide updated information to the processor-executable code 27 executed on the employee-computer device 14 or the manager-computer device 16 such as, for example, receipt of a query, confirmation of receipt of the query, an evaluated score, and/or a predictive analytics report, as will be discussed in further detail herein.

The non-transitory computer readable medium 30 may store the program logic 34 and may be implemented as, for example, random access memory (RAM), a CD-ROM, a hard drive, a solid-state drive, a flash drive, a memory card, a DVD-ROM, a disk, a non-transitory optical drive, combinations thereof, and/or the like.

In some embodiments, the non-transitory computer readable medium 30 may be located in the same physical location as the host system 12, and/or the non-transitory computer readable medium 30 may be located remotely from the host system 12. For example, the non-transitory computer readable medium 30 may be located remotely from the host system 12 and communicate with the processor 35 via the network 18. Additionally, when more than one non-transitory computer readable medium 30 is used, a first non-transitory computer readable medium 30 may be located in the same physical location as the processor 35, and additional non-transitory computer readable medium 30 may be located in a location physically remote from the processor 35. Additionally, the non-transitory computer readable medium 30 may be implemented as a “cloud” non-transitory computer readable storage memory (i.e., one or more non-transitory computer readable medium 30 may be partially or completely based on or accessed using the network 18).

The communication device 28 of the host system 12 may transmit data to the processor 35 and may be similar to the communication device 25 of the employee-computer device 14 and the manager-computer device 16. The communication device 28 may be located in the same physical location as the processor 35.

The non-transitory computer readable medium 30 may store processor executable code and/or information comprising the database 32 and the program logic 34. In some embodiments, the processor executable code may be stored as a data structure, such as the database 32 and/or data table, for example, or in non-data structure format such as in a non-compiled text file.

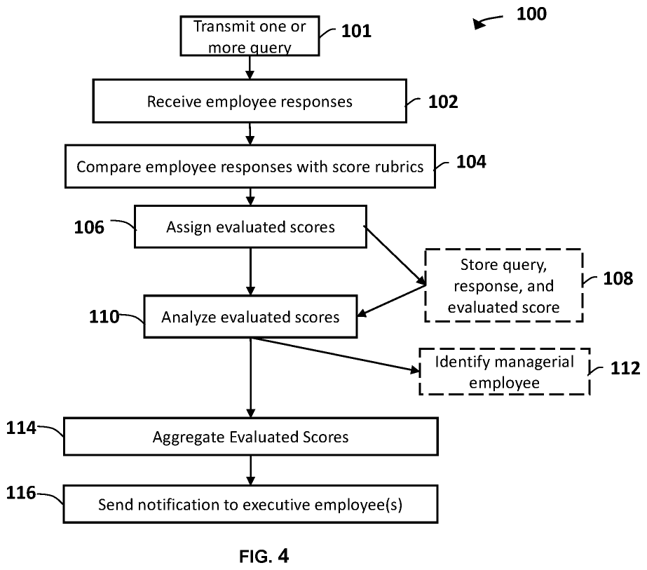

Referring now to FIG. 4, shown therein is a flow chart of an exemplary direct sentiment analysis method 100. In general, the sentiment analysis method 100 may include administering a plurality of employee surveys over time to identify shifts in employee sentiment, and/or to generate a predictive model of where employee sentiment is headed in the future based on trends of employee sentiment within the organization or the industry as a whole. In one embodiment, the sentiment analysis method may iteratively query and analyze responses from employees to determine current sentiment and predictive models.

The sentiment analysis method 100 may be implemented with the computerized system 10 as part of the program logic 34 of the host system 12, which when executed by the one or more processors 35 of the host system 12 may cause the one or more processors 35 to execute one or more of the steps of the method 100. For explanatory purposes, the sentiment analysis method 100 will be described as being carried out by the one or more processors 35 of the host system 12. However, in some implementations, the sentiment analysis method 100 may be implemented as part of the processor-executable code 27 carried out by the processor(s) 24 of the employee-computer device 14 and/or the manager-computer device 16. In some implementations, the sentiment analysis method 100 may be implemented partially with the program logic 34 of the host system 12 and partially with the processor-executable code 27 carried out by the processor(s) 24 of the employee-computer device 14 and/or the manager-computer device 16.

In a step 101 of the sentiment analysis method 100, the program logic 34 may cause the one or more processors 35 of the host system 12 to send a signal indicative of a query to the one or more employee-computer devices 14, such as via the communication device 25 and the network 18.

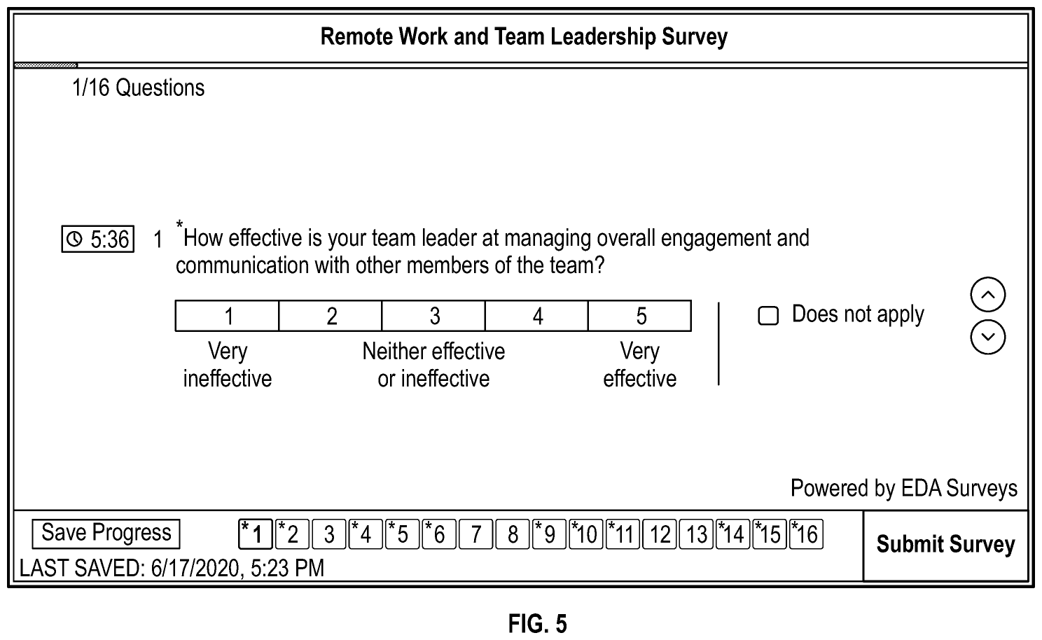

In some implementations, the query may be an electronic survey. The query may comprise one or more questions and metadata. FIG. 5 illustrates an exemplary question of a query.

The metadata may comprise one or more of: a question identifier unique to the one or more questions of the query, a response identifier indicative of a corresponding score rubric for the query, and an employee identifier indicative of the identity of the one or more employees. The employee identifier may be stored such as in the one or more databases 32 of the non-transitory computer readable medium 30; however, reporting of sentiment may be at a group level such that an individual employee is not identifiable to other employees, such as supervisory, managing, and/or executive employees.

In some embodiments, the question identifier may further include a competency identifier indicative of the question being related to organizational performance. For example, the competency identifier may include one or more of: Vision & Strategy, Values, Executive & Senior Leadership, Immediate Supervision, Communication, Innovation and Change Management, Customer Centricity, Social Impact, Diversity & Inclusion, Engagement, Teamwork, and Learning & Development. The competency identifier may be defined by supervisory/managerial employees of a particular organization.

Further, in some embodiments, the employee identifier may further include organizational structure data for an organization. Organizational structure data may include data regarding relationships between the employee and the organization, nonexclusive examples of which include data regarding the supervisor/manager(s) of the employee, co-workers of the employee, subordinates of the employee, position of the employee, department of the employee, and division of the employee. In some implementations, the data contained in the employee identifier may be insufficient to identify the name or other personal characteristics of an individual employee, or the identifying data may be removed from reports to other employees.

In some implementations, the question identifier may be a tag which indicates the corresponding text to be inviting a response, the response identifier may be a tag which indicates the corresponding text to be the employee response, and/or the employee identifier may be a tag which identifies a particular respondent. It should be noted, that in some embodiments, the question identifier, response identifier, and employee identifier may not be displayed and/or visible on the employee-computer device 14 and/or to other employees.

The query may comprise one or more questions for the one or more employees. For example, the query may request the one or more employees to answer one or more questions about each of their corresponding supervisors/managers, subordinates, colleagues, and/or the organization to which they belong.

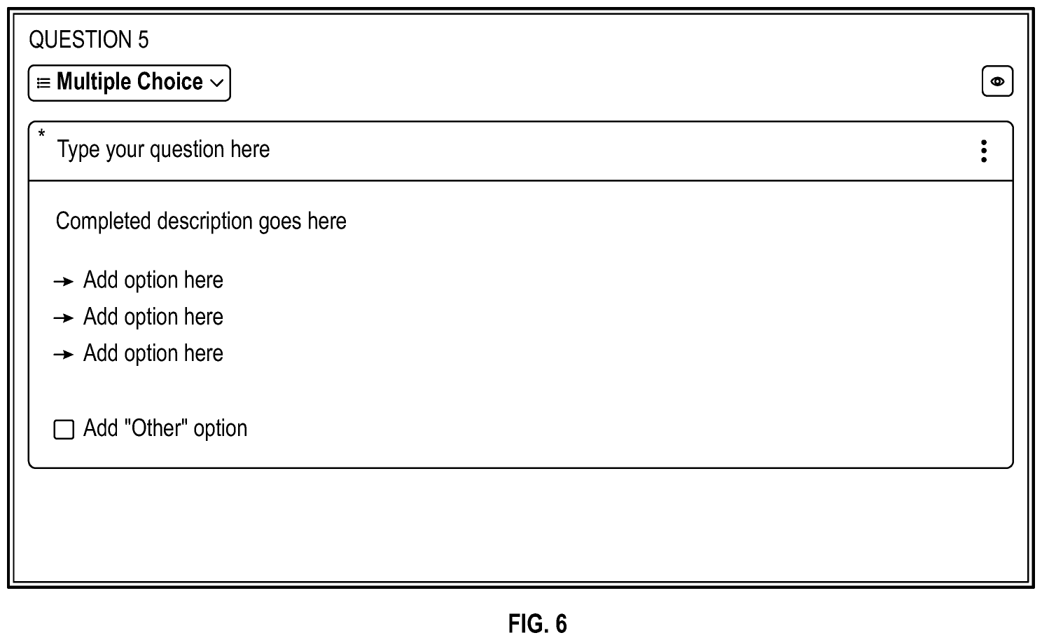

As shown in FIG. 6, in some implementations, the program logic 34 may cause the one or more processors 35 of the host system 12 to receive input to generate the query based on input from one or more supervisory/managerial employees. For example, the one or more supervisory/managerial employees, through the manager-computer device 16, may input one or more questions into a survey query to be sent to the one or more employees. Also, in some embodiments, the query may be generated by one or more supervisory/managerial employees selecting from a predetermined set of questions.

In some embodiments, the program logic 34 may cause the one or more processors 35 of the host system 12 to receive the employee response to the query in the form of one or more of the following: words, numeric values, or selection(s) of predetermined responses. For example, a question in the query may request the one or more employees to describe, in words, their past experiences with one or more supervisory/managerial employees. For another example, a question in the query may request the one or more employees to rate the effectiveness of one or more supervisory/managerial employees using a numeric scale, by either entering a numeric value or selecting a predetermined response reflecting a particular numeric value, as shown in FIG. 5.

Returning now to FIG. 4, in a step 102 of the sentiment analysis method 100, the program logic 34 may cause the one or more processors 35 of the host system 12 to receive one or more employee responses to one or more queries. The one or more processors 35 may receive the employee response to the query within a predetermined time, regardless of whether the employee answered some or all of the questions presented by the query. For example, the one or more processors 35 may receive the one or more employee's answers to an electronic survey.

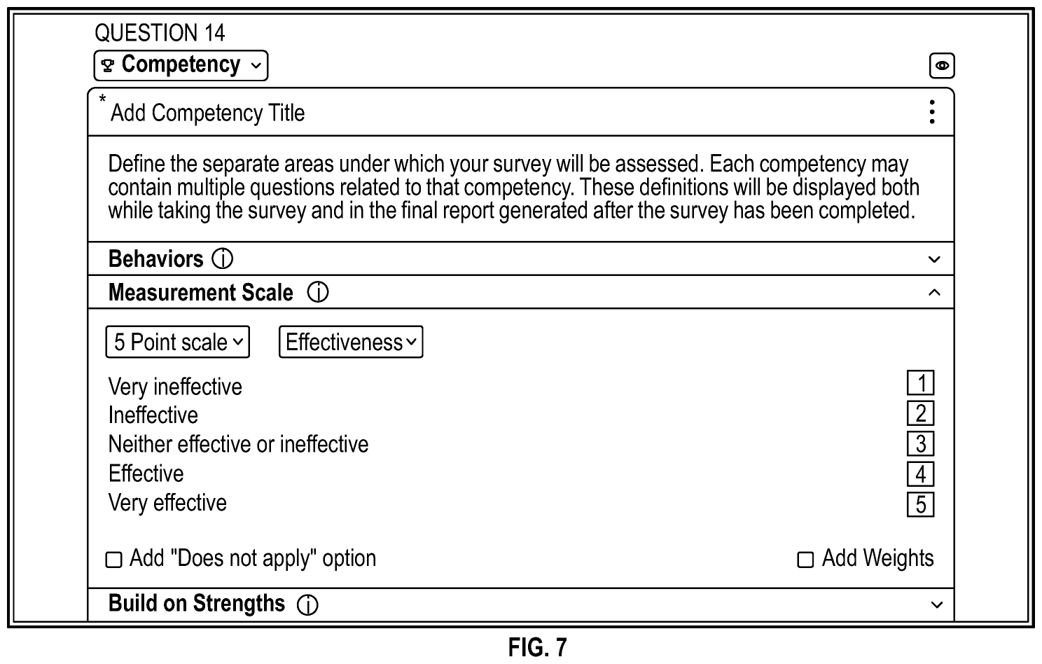

In a step 104, the program logic 34 may cause the one or more processors 35 of the host system 12 to compare the received employee responses to the queries with corresponding score rubric. For example, the one or more processors 35 may compare the employee response to an electronic survey about job satisfaction with a score rubric that corresponds to surveys about job satisfaction. In some embodiments, the score rubric comprises a numeric value corresponding to each of the one or more responses to the one or more questions. For example, an employee response about job satisfaction that was answered by selecting predetermined answers may be compared to a score rubric for surveys about job satisfaction where each predetermined answer corresponds to a numeric value indicative of a particular level job satisfaction, as shown in FIG. 7.

The corresponding score rubric may be stored on the employee-computer device 14, the manager-computer device 16, and/or may on the host system 12 in the database 32, for instance, and accessed over the network 18.

In a step 106, the program logic 34 may cause the one or more processors 35 of the host system 12 to assign evaluated scores to the employee responses based on the corresponding score rubrics. For example, the evaluated score may be the corresponding numeric value indicated on the corresponding score rubric for each answer to the one or more questions of the query. The one or more processors 35 of the host system 12 may access the database 32 to retrieve the corresponding score rubric.

In a step 108, optionally, the program logic 34 may cause the one or more processors 35 of the host system 12 to store the queries, the employee responses, and/or the evaluated scores on the one or more non-transitory computer readable medium 30 of the host system 12. In some embodiments, the query, the employee response, and the evaluated score are stored based on the employee identifier. For example, all queries, employee responses, and evaluated scores that correspond to a single employee identifier may be stored together.

In a step 110, the program logic 34 may cause the one or more processors 35 of the host system 12 to analyze the evaluated score to determine employee sentiment directed toward an entity associated with the query. For example, the evaluated score may be analyzed to determine employee sentiment as to entities such as peers, supervisors/managers, or an organization.

In some implementations, to determine employee sentiment, the program logic 34 may cause the one or more processors 35 of the host system to compare the evaluated score(s) with a threshold value based on the determined entity. Next, the program logic 34 may cause the one or more processors 35 of the host system 12 to determine the employee sentiment as one of the following: a positive sentiment, a negative sentiment, and a neutral sentiment.

In step 114, the program logic 34 may cause the one or more processors 35 of the host system 12 to aggregate or otherwise summarize the evaluated scores to determine employee sentiment within the organization for groups of employees. For example, the program logic 34 may cause the one or more processors 35 of the host system 12 to aggregate or otherwise summarize the evaluated scores to determine employee sentiment for teams, sections, divisions, and/or the organization as a whole.

In some implementations, the evaluated score may be a first evaluated score, and when analyzing the evaluated score to determine employee sentiment for groups of employees, the program logic 34 may cause the one or more processors 35 of the host system 12 to compare a second evaluated score with the first evaluated score and generate a predictive analytics report based on the comparison between the second evaluated score with the first evaluated score. For example, the second evaluated score may be an evaluated score that was previously stored on the one or more non-transitory computer readable medium 30 of the host system 12, which may then be compared to the most current evaluated score. The predictive analytics report may comprise a prediction of future employee sentiment for groups of employees based on the comparison between the second evaluated score with the first evaluated score. For example, if the comparison between the second evaluated score with the first evaluated score indicates a downward trend, the predictive analytics report may predict further downturn in future evaluated scores.

In an optional step 112 of the sentiment analysis method 100, the program logic 34 may cause the one or more processors 35 of the host system 12 to identify one or more supervisory/managerial employees. The one or more supervisory/managerial employees may be identified based on the employee identifier. For example, the identify of one or more supervisory/managerial employees may correspond to the employee identifiers of employees that the one or more supervisory/managerial employees directly supervise. However, it will be understood that the supervisory/managerial employees may be identified previously.

In a step 116, the program logic 34 may cause the one or more processors 35 of the host system 12 to send a notification to the one or more managerial employees indicative of the employee sentiment for groups of the employees. The notification may not include employee sentiment tied directly to an individual employee. For example, the one or more managerial employees may receive a notification indicating that employee sentiment for one or more groups of employees has not significantly changed since the last query was sent. In some embodiments, the notification to the one or more managerial employees may comprise of one or more of a confirmation of receipt of the query, the evaluated score, and/or the predictive analytics report. For example, the one or more managerial employees may receive a notification that states a query has been received, the evaluated score of the employee response to the query, and the predictive analytics report.

Further, it should be noted that one or more of the steps of method 100 may be repeated so as to generate trend data over a period of time. The trend data may be utilized to predict employee sentiment for one or more groups of employees based on the trend data. For example, the trend data may show that employee sentiment is improving over time, or becoming more negative over time, or remaining stationary over time.

In some implementations, the program logic 34 may cause the one or more processors 35 of the host system 12 to transform information regarding the employee sentiment of one or more groups of employees into one or more employee sentiment dashboards 150.

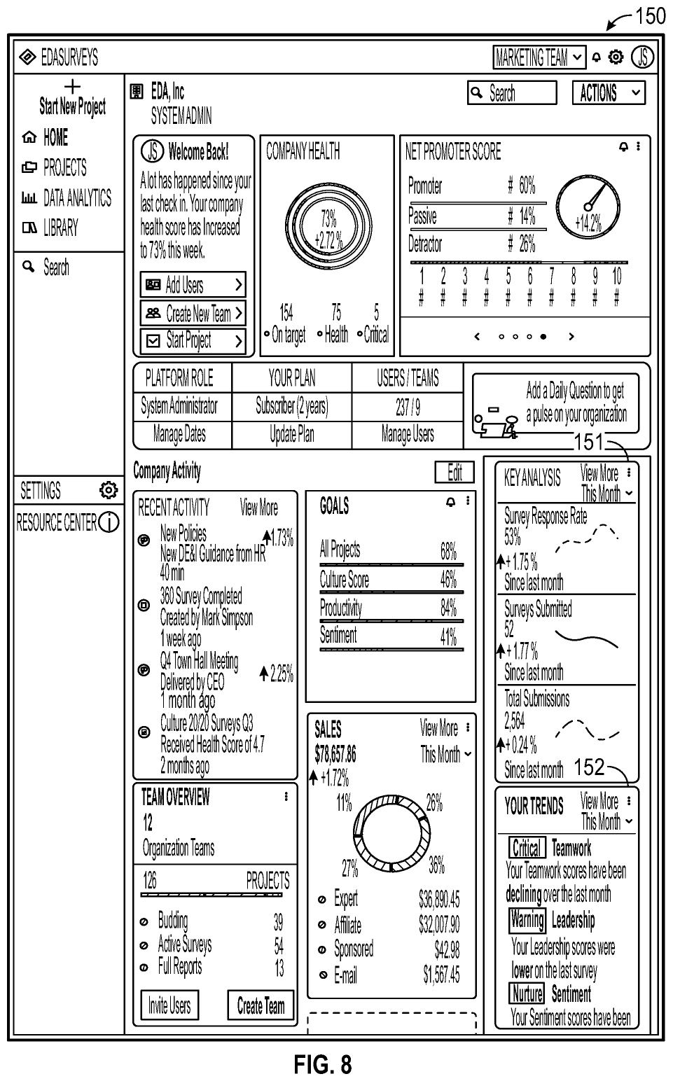

For example, in FIG. 8, shown therein is an illustration of an exemplary employee sentiment dashboard 150 in accordance with some embodiments of the present disclosure. The employee sentiment dashboard 150 may display key analysis information 151 regarding parameters such as, for example, completed and outstanding surveys and survey response rate.

The employee sentiment dashboard 150 may also display trend line overlays based on the trend data, and may optionally give a user access to further explanatory information to help interpret the trend line. The trend line may, for example, be indicative of employee sentiment over a period of time. Generalized employee sentiment conditions may be inferred from the directional movement of the trend lines. In some embodiments, the trend line may be a best fit line transposed upon averages of a number of data points indicative of employee sentiment at a particular period of time. In some embodiments, the trend line may be represented in a ring graph.

In some embodiments, the employee sentiment dashboard 150 may display employee sentiment conditions trend indicators 152, such as in a sentence format and/or through the use of predefined terminology indicative of the directional movement of the trend lines such, as for example, the terms “critical,” “warning,” or “nurture.”

The employee sentiment dashboard 150 may be generated upon request, at predetermined times, and/or based on a particular event, for example, if there is movement along the trend line that is indicative of a +/−1 standard deviation from the mean. The employee sentiment dashboard 150 may be displayed in a dashboard accessible by one or more users such as, for example, the CEO of an organization, or other designated C-suite or other leaders. The employee sentiment dashboard 150 does not include any personal identifiable information that would permit a supervisory/managerial employee to reasonably infer the identity of an employee that participated in the survey. It will be understood that the system may include other dashboards having other combinations and/or summaries of information regarding employee sentiment.

The employee sentiment dashboard 150 may be in the form of an interactive user interface configured to allow users to access aggregate and/or detailed information regarding employee sentiment for groups of employees and/or for different areas of organizational performance, though not identifying individual employees.

In some implementations, the program logic 34 may cause the one or more processors 35 of the host system 12 to determine employee sentiment in part through utilization of artificial intelligence, such as machine learning and/or neural networks, and generate notifications, which may include reports and/or dashboards, which may be in conjunction with and/or part of the employee sentiment dashboard 150. For example, the program logic 34 may cause the one or more processors 35 of the host system 12 to determine patterns in employee sentiment through review of terminology, language, or other factors in emails, chat systems, and/or other company communication systems, as will be discussed in further detail below. In some implementations, review of emails, chat systems, and/or other company communication systems may be performed with listening bots, that is, computer instructions that scan communications for particular terminology, language, or other factors.

In some implementations, the program logic 34 may cause the one or more processors 35 of the host system 12 to utilize artificial intelligence to determine employee sentiment by organizational category, such as by the same or similar categories as the competency identifier (for example, Vision & Strategy, Values, Executive & Senior Leadership, Immediate Supervision, Communication, Innovation and Change Management, Customer Centricity, Social Impact, Diversity & Inclusion, Engagement, Teamwork, and Learning & Development).

In some implementations, the program logic 34 may cause the one or more processors 35 of the host system 12 to receive employee input indicative of responses to one or more of the queries and may transform the input into one or more reports and/or dashboards regarding, for example, organizational performance.

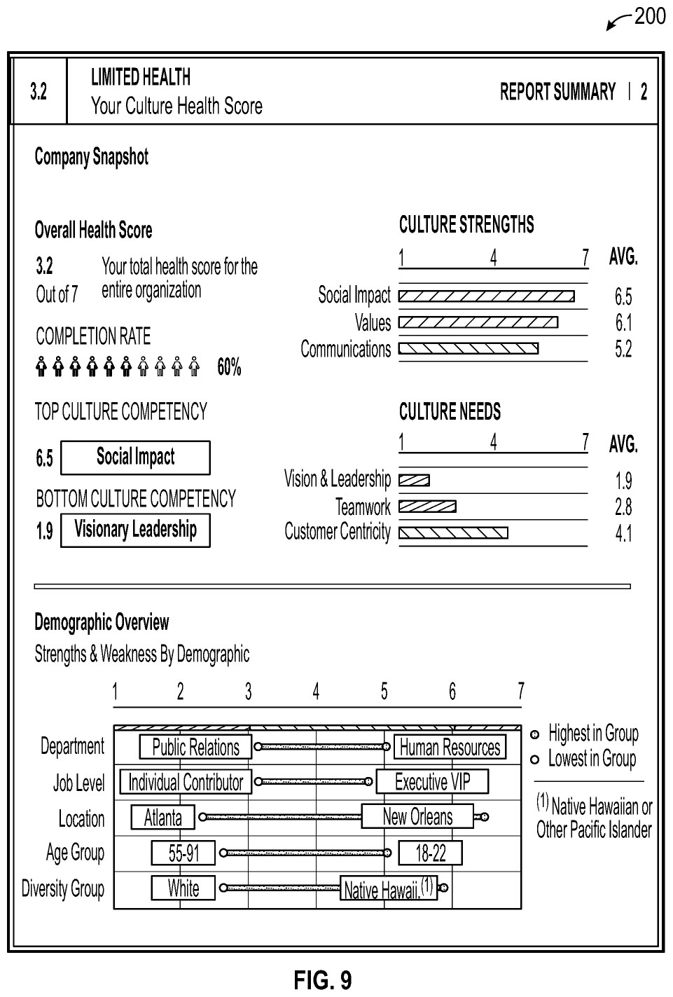

Referring now to FIG. 9, shown therein is an illustration of an exemplary organizational performance dashboard 200. The organizational performance dashboard 200 may provide information regarding the employee sentiment regarding various functions of organizational performance including, for example, one or more of the competency identifiers of the metadata of the queries, such as Vision & Strategy, Values, Executive & Senior Leadership, Immediate Supervision, Communication, Innovation and Change Management, Customer Centricity, Social Impact, Diversity & Inclusion, Engagement, Teamwork, and/or Learning & Development. The organizational performance dashboard 200 may be displayed in a dashboard accessible by one or more users such as, for example, the CEO of an organization, or other designated C-suite leaders. The organizational performance dashboard 200 does not include any personal identifiable information that would permit a managerial employee to reasonably infer the identity of an employee that participated in the survey. In some implementations, particular employees may be authorized to view employee identifiers, such as, for example, a human resources manager.

The organizational performance dashboard 200 may be in the form of an interactive user interface configured to allow users to access aggregate and/or detailed information regarding employee sentiment for groups of employees and/or for different areas of organizational performance, though not identifying individual employees.

In some implementations, the organizational performance dashboard 200 may display one or more charts indicative of employee sentiment from the queries, and/or from the utilization of artificial intelligence, regarding organizational performance based on various parameters including, by organizational department, job level, employee tenure, age group, and/or diversity group, and so on, as shown in FIG. 9.

The data for the organizational performance dashboard 200 may be based at least in part on responses to queries and the employee identifier, which may include organizational structure data, of the metadata of the queries, though the employee identifier may not be displayed in the organizational performance dashboard 200. The data for the organizational performance dashboard 200 may be based at least in part on the employee sentiment determined through utilization of artificial intelligence.

The chart may include averages of evaluated scores. In some implementations, the averages of the evaluated scores may be color-coded based on whether the sentiment regarding a particular organizational performance function is positive, negative, or neutral. The organizational performance dashboard 200 may also provide guidance for organizational leadership to correct negative or neutral organizational performance. The organizational performance dashboard 200 may also be filtered to provide only high-level information regarding employee sentiments for groups of employees with respect to organizational performance intended for a particular audience, for example, a board of directors of an organization, or potential investors or potential employees. The organizational performance dashboard 200 may be provided to high-level employees, such as chief executive officers and executive level employees, for example.

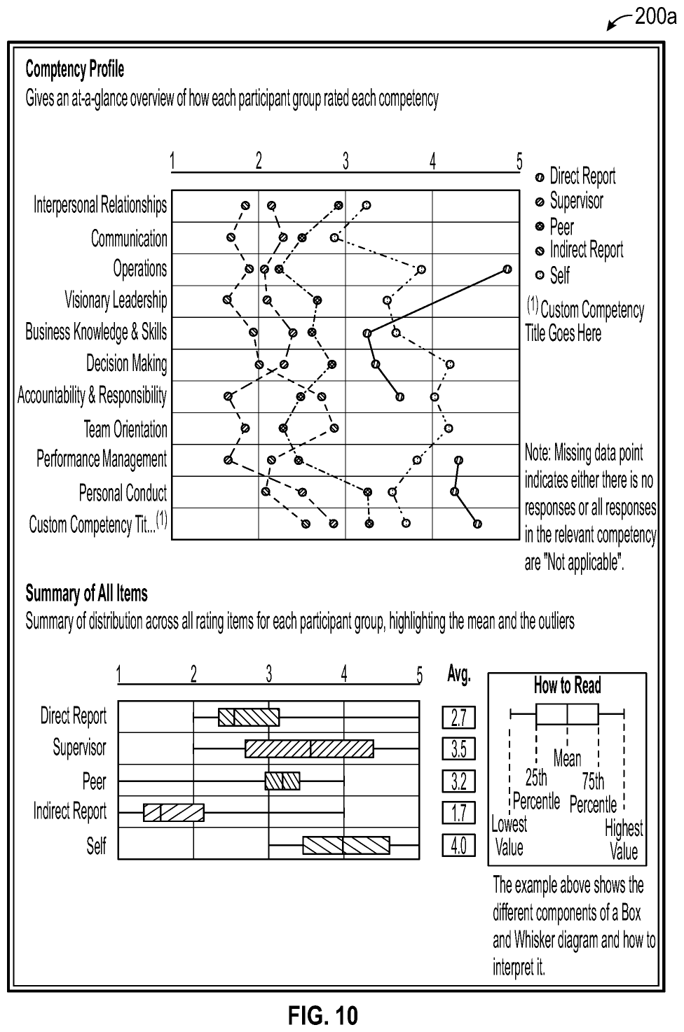

Referring now to FIG. 10, shown therein is an illustration of another exemplary organizational competency performance report 200a reporting competencies. In this embodiment, the organizational competency performance report 200a displays data indicative of how each organizational group, i.e., direct report, supervisor/manager, peer, and indirect report, rated a set of competencies indicative of organizational performance, such as, for example, interpersonal relationships, communication, operations, visionary leadership, business knowledge & skills, decision making, accountability and responsibility, team orientation, performance management, personal conduct, or any other pre-determined competency. The data for the organizational competency performance report 200a may be based at least in part on responses to queries and the competency identifiers of the metadata of the queries. In some implementations, the organizational competency performance report 200a may display a plot of data points indicative of an average evaluated score with regards to each competency. In some implementations, sets of data points may be color-coded to coordinate with corresponding organizational groups. The organizational competency report 200a may be displayed on a dashboard accessible by users such as, for example, the CEO of an organization, or other designated C-suite (that is, executive level) leaders. The organizational competency report 200a does not include any personal identifiable information that would permit a managerial employee to reasonably infer the identity of an employee that participated in the survey.

In some implementations, the program logic 34 may cause the one or more processors 35 of the host system 12 to create survey templates including one or more template queries and to receive employee input indicative of responses to the one or more template queries and may transform the input into one or more additional organizational performance reports. Nonexclusive examples of template queries and reports include Leadership Effectiveness, CEO Leadership Effectiveness, Physician Leadership Effectiveness, Healthcare Leadership Effectiveness, Department Effectiveness, 360-degree Surveys, Culture Survey, and Return-On-Investments Survey.

In some implementations, the program logic 34 may cause the one or more processors 35 of the host system 12 to receive organizational information from one or more external database. The program logic 34 may cause the one or more processors 35 of the host system 12 to incorporate the organizational information into one or more of: the employee sentiment dashboard 150, the organizational performance dashboard 200, the organizational competency performance report 200a, and the additional reports. In some implementations, the program logic 34 may cause the one or more processors 35 of the host system 12 to determine relationships between the organizational information and the input received from the queries. For example, an increase or decrease in sales or safety metrics may be compared to and/or associated with an increase or decrease in positive employee sentiment.

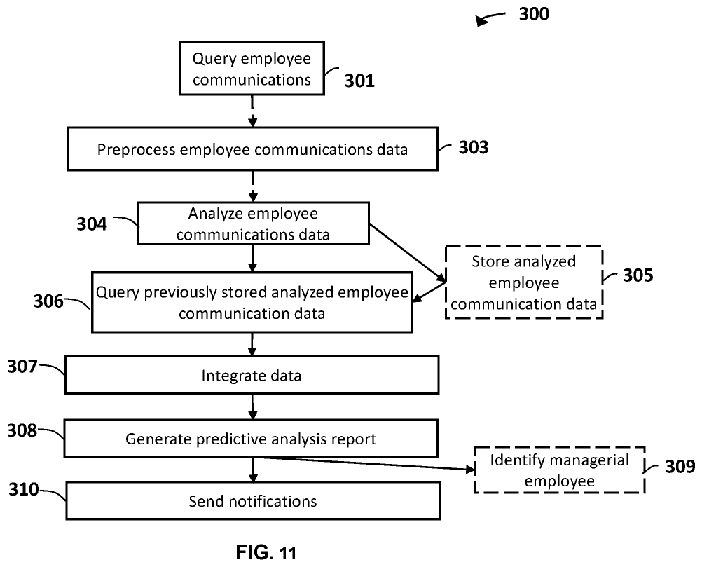

Referring now to FIG. 11, shown therein is a flow chart of an exemplary communication sentiment analysis method 300. In general, the communication sentiment analysis method 300 may include collection, review, and analysis of terminology, language, or other factors, in employee communications, such as emails, chat systems, and/or other company communication systems, over time to identify current employee sentiment, shifts in employee sentiment, and/or to generate a predictive model of where employee sentiment is headed in the future based on trends of employee sentiment, such as within the organization as a whole. In one embodiment, the communication sentiment analysis method 300 may iteratively query and analyze company communication systems to determine current sentiment and predictive models.

The communication sentiment analysis method 300 may be implemented with the computerized system 10 as part of the program logic 34 of the host system 12, which when executed by the one or more processors 35 of the host system 12 may cause the one or more processors 35 to execute one or more of the steps of the method 300. For explanatory purposes, the communication sentiment analysis method 300 will be described as being carried out by the one or more processors 35 of the host system 12. However, in some implementations, the communication sentiment analysis method 300 may be implemented as part of the processor-executable code 27 carried out by the processor(s) 24 of the employee-computer device 14 and/or the manager-computer device 16. In some implementations, the communication sentiment analysis method 300 may be implemented partially with the program logic 34 of the host system 12 and partially with the processor-executable code 27 carried out by the processor(s) 24 of the employee-computer device 14 and/or the manager-computer device 16.

In a step 301 of the communication sentiment analysis method 300, the program logic 34 may cause the one or more processors 35 of the host system 12 to send a signal indicative of a query to the one or more employee-computer devices 14, such as via the communication device 25 and the network 18. In some implementations, the program logic 34 may cause the one or more processors 35 of the host system 12 to send a signal indicative of a query to one or more communications devices 350, nonexclusive examples of which include one or more of communications server(s), distributed company-owned device(s) (for example, sensors, routers, etc.), and/or employee-specific device(s). The communications device(s) 350 may be configured to accept input of, track, process, and/or store employee communications.

In some implementations, the query may be an electronic request for one or more employee communications sent or received by the one or more communications device 350. As used herein, the term “communications” may refer to any digital communication of a user, and may in at least some implementations include one or more of multimedia messages, e-mail messages, instant messages, audio messages, images, symbols, text messages, and textual messages that include additional non-text items. In some implementations, the communications may be converted to text. For example, audio messages may be partially or completely converted to text. In another example, emojis may be associated with text-based representations and/or converted to text.

In some implementations, the program logic 34 may cause the one or more processors 35 of the host system 12 to receive one or more employee communications, such as in response to the query step 301.

In a step 303, optionally, the program logic 34 may cause the one or more processors 35 of the host system 12 and/or of a source device, such as the employee-computer device 14 or manager-computer device 16, to preprocess the employee communications for later analysis. Preprocessing employee communication may include transforming the employee communications into a form that is capable of further analysis. In some implementations, the employee communications are preprocessed using natural language processing techniques including, for example, sentence boundary detection, tokenization, entity extraction, stemming, lemmatization, stop word removal, and spelling correction.

In a step 304, the program logic may cause the one or more processors 35 of the host system 12 to analyze the employee communications and/or the preprocessed employee communications data of step 303 to determine employee sentiment directed toward an entity or an organization referenced in the employee communications.

In some implementations, the program logic 34 may cause the one or more processors 35 of the host system 12 to determine employee sentiment by category, in part, utilizing artificial intelligence, such as one or more language model created with machine learning algorithms, to classify the employee communications or the preprocessed employee communications data into different categories such as, for example by the same or similar categories as the competency identifier (for example, Vision & Strategy, Values, Executive & Senior Leadership, Immediate Supervision, Communication, Innovation and Change Management, Customer Centricity, Social Impact, Diversity & Inclusion, Engagement, Teamwork, and Learning & Development). In some implementations, classifying the employee communications or the preprocessed employee communications data into different categories may comprise determining whether the employee communications include indications of employee sentiment about one or more of the organizational categories, such as by utilizing or more language model.

In some implementations, the program logic 34 may cause the one or more processors 35 of the host system 12 to determine employee sentiment by utilizing a language model. The language model may be utilized to review the employee communications and/or the preprocessed employee communications data to identify employee sentiment, subject matter topics, entities, and/or organizations that are referenced, or otherwise present, in the employee communications.

In some implementations, the program logic 34 may cause the one or more processors 35 of the host system 12 to determine a language model using, for example, supervised and/or unsupervised machine learning algorithms. For example, an unsupervised machine learning algorithm may be utilized to analyze and cluster large, unstructured text data associated with the employee communications to derive one or more language models.

Further, in some implementations, supervised machine learning algorithms may be utilized to analyze labeled datasets associated with the employee communications (which may be referred to as training data) to train the machine learning algorithms into a language model to accurately classify the employee communications and/or predict outcomes such as, for example, employee sentiment. The supervised machine learning algorithm may utilize, for example, linear regression, logistic regression, and polynomial regression analysis; neural networks; and/or Bayesian modeling to classify the employee communications and/or predict outcomes such as, for example, employee sentiment and/or predicted future employee sentiment.

In some implementations, the program logic 34 may cause the one or more processors 35 of the host system 12 to utilize an unsupervised language model to transform data associated with the employee communications and a regression classifier to perform a classification of the employee communications into the same or similar categories as the competency identifier.

The language model(s) may be utilized to analyze the employee communications and determine whether the employee communications include indications of employee sentiment about one or more of the organizational categories and/or to classify the employee communications as containing employee sentiment about one or more of the categories.

Further, in some implementations, the program logic 34 may cause the one or more processors 35 of the host system 12 to assign a fit score based on the classification of the employee communications into one or more of the categories. For example, the fit score may be a numeric value indicative of how well the employee communications were mapped into the classification categories. The fit score may be indicative of how closely a particular employee communication is associated with a particular category. The fit score may be indicative of a relational probability of the employee communication fitting into the category. In some implementations, the fit score may be a value from 0 to 1 (or 0% to 100%).

In some implementations, the trained machine learning algorithms may be used to classify the employee communications into one or more of the categories and the fit score may be based on training data used for training the machine learning algorithms.

The fit score may be specific to a particular individual output of the machine learning algorithms, that is, the fit score may be specific to the mapping of a particular employee communication to a particular category by the machine learning algorithms. The fit score may be a relative ranking based on other employee communications mapped to the particular category.

A particular employee communication may be assigned multiple fit scores and the employee communication may be mapped to multiple categories with different fit scores. For example, hypothetically, an employee communication may be mapped to both a “Communication” category as well as a “Vision & Strategy” category, and may have individual fit scores for each category, which may be different, or the same, fit scores.

As a hypothetical example, for an exemplary employee communication that included the text, “We offer flexible hours and the necessary tools for your success”, the program logic 34 may cause the one or more processors 35 of the host system 12 to associate the text with the category “Learning & Development” and with the category “Engagement”, such as by utilizing the trained machine learning algorithms (the language model). The program logic 34 may cause the one or more processors 35 of the host system 12 to assign a first fit score of 0.9 for that employee communication for the category “Learning & Development” and may assign a second fit score of 0.7 for that communication for the category “Engagement”, based on the trained machine learning algorithms. In some implementations, when comparing multiple fit scores for the particular employee communication that has been mapped to different categories, higher scores would imply a stronger relationship/connection to that mapped-to category than lower scores.

In some implementations, when comparing multiple fit scores across multiple different employee communications that have been mapped to different categories, higher scores would imply a stronger relationship/connection to that category than lower scores to other categories.

In some implementations, when comparing multiple fit scores across multiple different employee communications that have been mapped to the same category, higher scores would imply a stronger relationship/connection to that category than lower scores.

In some implementations, a predetermined threshold value may be established. In some implementations, if the fit score is at or above the predetermined threshold value, then the employee communication may be placed into a bin labeled with the name of the category. In some implementations, if the fit score is at or above the predetermined threshold value, then the employee communication may be added to a numeric count for employee communications in the category. For example, the numeric count may add a 1 or some other integer value, or the score itself, a floating point number (0 to 1), or other count for the category.

In some implementations, if the fit score is at or above the predetermined threshold value, then the program logic 34 may cause the one or more processors 35 of the host system 12 to conduct further analysis. For example, further analysis may result in further information being extracted from the employee communications, such as, but not limited to, modeling the topics communicated in text within the category, and/or extracting meaning/semantics that are mapped to additional models. In some implementations, if the fit score is below the predetermined threshold value, then the program logic 34 may cause the one or more processors 35 of the host system 12 to conduct further analysis. In some implementations, if the fit score is below the predetermined threshold value, then the program logic 34 may cause the one or more processors 35 of the host system 12 to ignore or disregard the employee communication as it relates to the category having the fit score below the predetermined threshold value.

In some implementations, the numerical value of the fit score may be used for further analysis. For example, the fit scores may be aggregated. In some implementations, the fit scores may be used for further analysis, whether or not the fit scores are at or above the predetermined threshold value. In some implementations, the system may aggregate the fit scores for a category for multiple communications with or without a threshold score. For example, the system may aggregate all the scores and/or the system may only aggregate scores above a threshold score.

In some implementations, the program logic 34 may cause the one or more processors 35 of the host system 12 to utilize the fit score as an input to additional layers of machine learning algorithms. As hypothetical examples, the fit score may be used as an input to one or more of: a machine learning model for predicting company financial performance such as, for example, percent increase in gross revenue, or a machine learning model for predicting organizational human resource metrics such as, for example, employee retention, or machine learning models for making other predictions regarding organizational performance.

In a step 305, the program logic may cause the one or more processors 35 of the host system 12 to store the analyzed data associated with the employee communications, such as the determined employee sentiment, the category classification data, and/or the fit scores from step 305 on the one or more non-transitory computer readable medium 30 of the host system 12. In some embodiments, the analyzed employee communications data may be stored based on further identifying data such as, for example, the employee identifier.

In a step 306, the program logic 34 may cause the one or more processors 35 of the host system 12 to aggregate analyzed data associated with employee communications for further analysis and/or modeling. For example, the aggregate data may include the most recent analyzed employee communications data, including classification data and/or fit scores, and historical employee communication data associated with past analysis of employee communications that have been previously stored on the one or more non-transitory computer readable medium 30 of the host system 12.

In some implementations, the program logic 34 may cause the one or more processors 35 of the host system 12 to aggregate the classification data obtained from step 304 with historical classification data associated with past analysis of employee communications for further predictive analysis and modeling. In some implementations, the program logic 34 may cause the one or more processors 35 of the host system 12 to query the non-transitory computer readable medium 30, and receive therefrom, data associated with past analysis of employee communications, including, for example, classification of employee communications, corresponding fit scores, and/or any sentiment or topic analysis that may have been performed, along with the most recently analyzed data associated with employee communications. In a step 307, the program logic 34 may cause the one or more processors 35 of the host system 12 to integrate interrelated data regarding employee sentiment. For example, the integrated data may include the evaluated scores from step 106 of sentiment analysis method 100, the evaluated score analysis data from step 110 of sentiment analysis method 100, and the aggregated classification and/or fit score data of step 306.

In some implementations, in a step 308, the program logic 34 may cause the one or more processors 35 of the host system 12 to generate a predictive analysis report based on the integrated data from step 307.

In some implementations, the program logic 34 may cause the one or more processors 35 of the host system 12 to compare a first set of employee sentiment data such as, for example, the most recent classification data, fit scores, evaluated score, and/or evaluated score analysis data, with a second set of employee sentiment data such as, for example, historical classification data, fit score, evaluated score, and/or evaluated score analysis data that were previously stored on the one or more non-transitory computer readable medium 30 of the host system 12.

The predictive analysis report may comprise a prediction of future employee sentiment for individual employees and/or groups of employees based on the comparison between the first set of employee sentiment data and second set of employee sentiment data. For example, if the comparison between the second set of employee sentiment data with the first set of employee sentiment data indicates a downward trend, the predictive analytics report may predict further downturn in future employee sentiment.

In an optional step 309, the program logic 34 may cause the one or more processors 35 of the host system 12 to identify one or more supervisory/managerial employees. The one or more supervisory/managerial employees may be identified based on the employee identifier. For example, the identify of one or more supervisory/managerial employees may correspond to the employee identifiers of employees that the one or more supervisory/managerial employees directly supervise. However, it will be understood that the supervisory/managerial employees may be identified previously.

In some implementations, in a step 310, the program logic 34 may cause the one or more processors 35 of the host system 12 to send a notification to the one or more managerial employees indicative of the prediction of future employee sentiment based on the predictive analysis report for groups of the employees. For example, the one or more managerial employees may receive a notification indicating that predicted future employee sentiment for one or more groups of employees has not significantly changed since the last notification was sent. In some embodiments, the notification to the one or more managerial employees may include the predictive analysis report.

In some implementations, the program logic 34 may cause the one or more processors 35 of the host system 12 to generate one or more reports, such as one or more dashboard, including the exemplary dashboards discussed herein, having results of employee sentiment data analyses.

### CONCLUSION

Conventionally, employee sentiment regarding an organizational entity or the organization itself is primarily obtained at discrete points of time, permitting only a limited snapshot of employee sentiment at a given time. Typically, this is achieved through single point-in-time surveys, which are inadequate to measure real-time sentiment, or identify shifts in sentiment, or generate a predictive model of employee sentiment. In accordance with the present disclosure, computerized methods and systems are disclosed to determine sentiment of employees in an organization through analysis of passive and/or interactive inputs. More particularly the computerized methods and systems receive digital employee communications; and determine employee sentiment from the digital employee communications by analyzing the digital employee communications utilizing a language model generated by machine learning algorithms. In some implementations, the executable instructions, when executed, may cause the one or more processors to determine whether the employee communications include indications of employee sentiment about one or more organizational categories and/or may determine trends in or predictions of employee sentiment.

In some implementations, the computerized methods and systems may transmit a query to one or more employee devices, posing one or more survey questions. Once the one or more employees respond to the query, the response may be compared with a score rubric that corresponds to the query and an evaluated score may be assigned to corresponding responses based on the query. The evaluated scores may then be valuated to determine employee sentiment as directed towards an entity associated with the query by comparing the evaluated score with a threshold value based on the entity to determine whether the employee sentiment is either positive, negative, or neutral. Once the employee sentiment has been determined, one or more managerial employee(s) (such as, for example, executive-level employees) may be able to view employee sentiment information for groups of employees up to, and including, the entire organization.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

What is claimed is:

1. A computerized system, comprising:
one or more non-transitory computer readable medium storing computer executable instructions that, when executed, cause one or more processors to:
receive digital employee communications; and
determine employee sentiment from the digital employee communications by analyzing the digital employee communications utilizing a language model generated by machine learning algorithms.

2. The computerized system of claim 1, wherein the digital employee communications contain text.

3. The computerized system of claim 1, wherein the digital employee communications are at least partially converted to text.

4. The computerized system of claim 1, wherein the machine learning algorithms include one or more of linear regression, logistic regression, polynomial regression analysis, neural networks, and Bayesian modeling.

5. The computerized system of claim 1, wherein determining employee sentiment further comprises determining employee sentiment for one or more organizational categories.

6. The computerized system of claim 5, wherein the one or more organizational categories include one or more of vision and strategy, values, leadership, supervision, communication, innovation and change management, customer centricity, social impact, diversity, inclusion, engagement, teamwork, and learning and development.

7. The computerized system of claim 5, wherein determining employee sentiment from the digital employee communications by analyzing the digital employee communications utilizing the language model generated by machine learning algorithms further comprises determining whether the employee communications include indications of employee sentiment about one or more of the organizational categories.

8. The computerized system of claim 7, the one or more non-transitory computer readable medium storing computer executable instructions that, when executed further cause the one or more processors to assign a fit score to a corresponding determination of whether the employee communications include indications of employee sentiment about one or more of the organizational categories, wherein the fit score is indicative of a relational probability of the employee communication fitting into the organizational category.

9. The computerized system of claim 1, the one or more non-transitory computer readable medium storing computer executable instructions that, when executed further cause the one or more processors to determine future trends of employee sentiment by tracking the determined employee sentiment over time.

10. The computerized system of claim 1, wherein the language model is a first model, and wherein the one or more non-transitory computer readable medium storing computer executable instructions that, when executed, further cause the one or more processors to analyze the determined employee sentiment using a second model generated by machine learning algorithms.

11. A computerized method, comprising:
determining, with one or more computer processors, employee sentiment from digital employee communications by analyzing the digital employee communications utilizing a language model generated by machine learning algorithms.

12. A computerized system, comprising:
one or more non-transitory computer readable medium storing computer executable instructions that, when executed, cause one or more processors to:
transmit one or more queries to one or more employee-computer devices, wherein the one or more queries comprises one or more questions for two or more employees;
receive employee responses to the one or more queries from the one or more employee-computer devices within a predetermined time;
compare the employee responses with one or more corresponding score rubrics;
assign evaluated scores to the employee responses to the queries based on the one or more corresponding score rubrics;
analyze the evaluated scores to determine employee sentiment of the two or more employees directed toward an entity associated with the one or more queries, by comparing the evaluated scores with a threshold value based on the entity to determine that the employee sentiment of the two or more employees is one of: a positive sentiment, a negative sentiment, and a neutral sentiment; and
generate a notification to one or more executive employees indicative of the employee sentiment of the two or more employees.

13. The computerized system of claim 12, wherein the query comprises metadata including a question identifier unique to the one or more questions of the query, a response identifier indicative of the corresponding score rubric for the query, and an employee identifier indicative of identity of the one or more employees.

14. The computerized system of claim 13, wherein the question identifier includes a competency identifier indicative of organizational performance.

15. The computerized system of claim 13, wherein the employee identifier includes organizational structure data for an organization.

16. The computerized system of claim 12, wherein the query is generated by the one or more executive employees.

17. The computerized system of claim 12, wherein the query comprises metadata including a competency identifier indicative of which functions of organizational performance are associated with the one or more questions.

18. The computerized system of claim 17, wherein the functions of organizational performance include one or more of: interpersonal relationships, communication, team orientation, accountability and responsibility, personal conduct, performance management, operations, business knowledge, and skills, decision making, visionary leadership, decision making, problem solving, adaptability, leading change, leading teams, leading self, communication, developing people, business and financial acumen, and applied systems thinking.

19. The computerized system of claim 12, wherein the employee response to the query comprises one or more of: words, numeric values, and one or more choices from predetermined responses.

20. The computerized system of claim 12, wherein the evaluated score is a first evaluated score, and wherein analyzing the evaluated score to determine employee sentiment comprises:
comparing a second evaluated score with the first evaluated score; and
generating a predictive analytics report based on the comparison between the second evaluated score with the first evaluated scores, wherein the predictive analytics report comprises a prediction of future employee sentiment based on the comparison between the second evaluated score with the first evaluated score.
